(19) United States
(12) Patent Application Publication
(10) Pub. No.: US 2014/0113468 A1
(43) Pub. Date: Apr. 24, 2014

(54) Electrical Cover Receptacle With Integrated Safety Device

(71) Applicant: Joshua Kaplan, (US)

(72) Inventor: Theodore McBane, Santa Clara, CA (US)

(73) Assignee: Joshua Kaplan, Passaic, NJ (US)

(21) Appl. No.: 13/685,700

(22) Filed: Nov. 26, 2012

Related U.S. Application Data
(60) Provisional application No. 61/563,578, filed on Nov. 24, 2011.

(51) Int. Cl. H01R 13/443

(52) U.S. Cl. CPC H01R 13/443
USPC 439/148

(57) ABSTRACT

An outlet cover safety device with an integrated safety device having an electrical with at least one aperture. The electrical cover mounting on an electrical outlet. The matching up with electrical gangs of the electrical outlet. The safety device having a at least one strap, with at least one prong disposed on the strap. The strap being biased to remain in an open position away from the plug accepting outlet when not in use. When wishing to engage the safety device, the strap is bent in a direction such that the prong is gets inserted into an aperture of a plug receiving outlet. The safety device may be incorporated with an outlet cover or may be a separate mechanism.

### CLAIM OF PRIORITY

This application claims prior of a U.S. Patent No. 61/563,578 filed on Nov. 24, 2011, the contents of which are fully incorporated herein by reference.

### FIELD OF INVENTION

The present invention relates to a safety device that may be manufactured together with or separate from a cover apparatus that it secures.

### BACKGROUND OF THE INVENTION

In residential and other structures, electrical outlets are generally positioned a short distance above the floor, this makes the outlets readily accessible to small children. A curious child is inclined to test and probe his environment and may insert objects, such as paper clips and parts of toys into the prong receiving openings of an electrical outlet. This exposes this child to the danger of shock or even death.

Electrical outlet covers have been known for a long time. Over the years many products have been introduced to deal with the danger that electricity poses to young children. Some have become ubiquitous household items, such as a freestanding disk with a pair of prongs on one side that get inserted into an outlet.

Even though the present field of the art seems saturated with numerous safety devices, they all represent separate items that are not attached to the covers they are supposed to shield. Therefore, these devices frequently get lost and most be incessantly replaced with new ones. While they are being replaced children are exposed to increased risk of electrocution from unshielded outlets.

A small number of existing electrical covers do integrate safety features into a an electric cover receptacle. However, these tend to be complex devices that are expensive to mass produce. This results in higher retail price which discourages all but the most safety conscious consumers from buying them.

The present invention may be similarly adapted for use in network and phone plug-in outlets, microphone jacks, audio/video outlets and other plug-in devices. While these usually do not present a risk of electric shock, a safety shield will prevent other negative consequences, such as stuck limbs and damaged and broken outlets.

The present invention solves all of the aforementioned flaws present in prior art and introduces other novel and non-obvious breakthroughs.

### SUMMARY OF THE INVENTION

The present invention is an electrical outlet cover apparatus, having at least one aperture for receiving an outlet, at least one strap having a band and a cap, the strap capable of flexing from the point of attachment to top surface of the cover, the cover surface further containing prongs that engage plug receiving aperture of the electrical outlet, said safety member fused with said receptacle cover during manufacturing as in injection molding process.

It is the purpose of the present invention to provide an electrical receptacle cover featuring an integrated safety mechanism that is simple to operate and inexpensive to manufacture.

It is the purpose of the present invention to provide a safety mechanism that mounts between the cover and the wall on which the cover is mounted. This configuration ensures that the safety device will not get detached.

It is another purpose of the present invention to provide a safety device that mounts using a flange or gasket. This ensures an air tight, even seal, as well as secure durable installation.

### BRIEF DESCRIPTION OF THE DRAWINGS

FIG. 1 is a perspective top view of the present invention with safety mechanism in a disengaged state.

FIG. 2 is a perspective top view of the present invention with safety mechanism in an engaged position.

FIGS. 2A-2I are various views of the first embodiment of the present invention.

FIGS. 3A-3E are various views of the second embodiment of the present invention.

FIGS. 4A and 4B are alternative applications of the present invention.

### DETAILED DESCRIPTION OF THE INVENTION

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

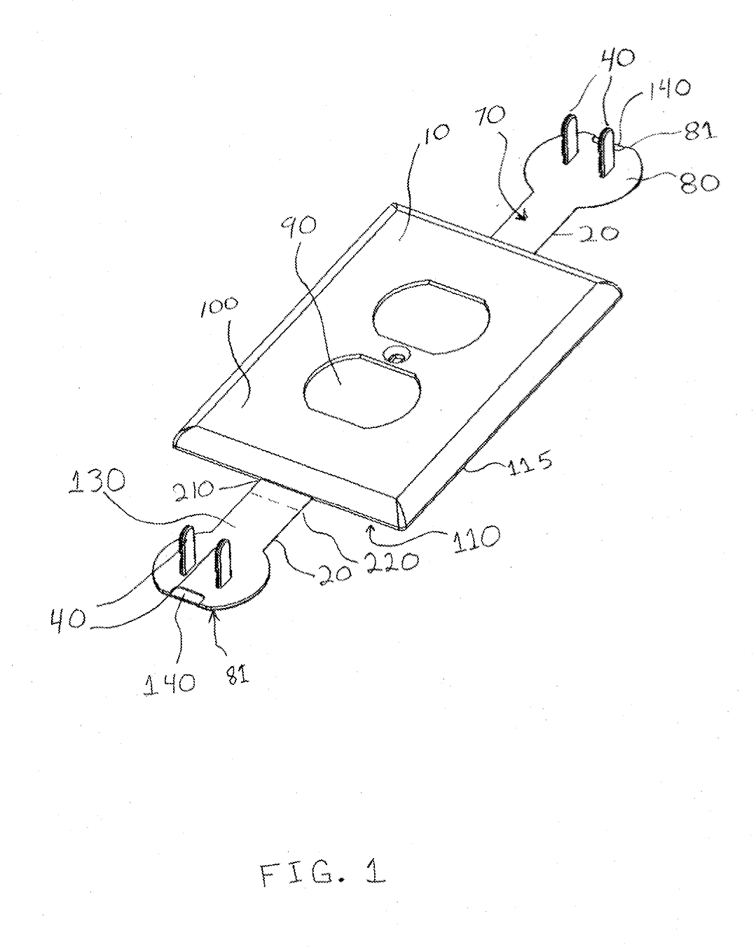

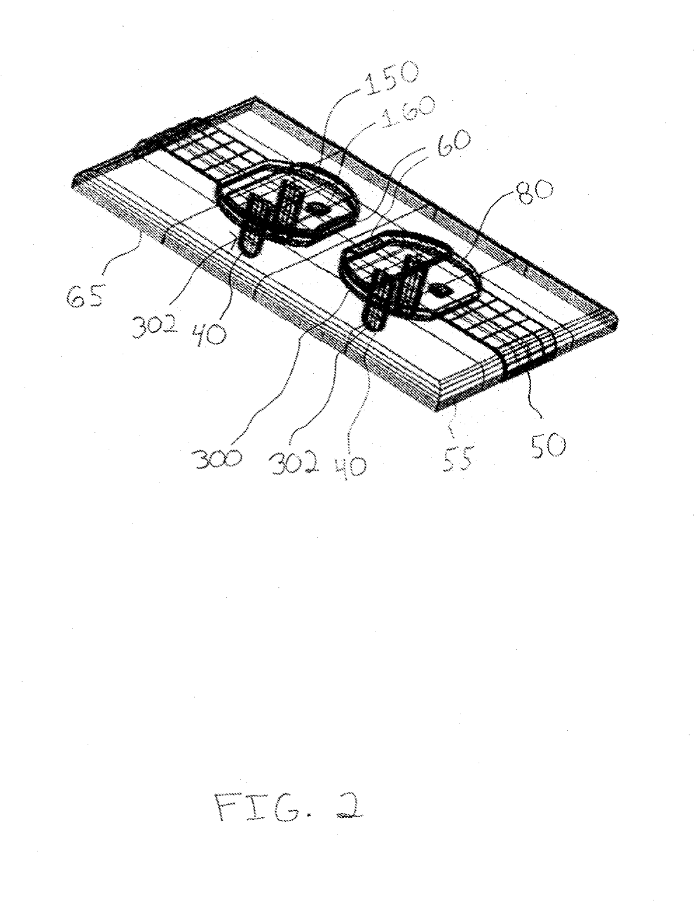

FIG. 1 is a perspective view of the preferred embodiment of the present invention. Shown are the receptacle cover 10, straps 20, prongs 40, a first point 50, a second point 60, the band 70, the cap 80, the aperture 90, the top surface of the receptacle cover 100, bottom surface of the cover 110, the top surface of the strap 120, the bottom surface of the strap 130, and the nail slot 140. The strap 20 and the receptacle cover 10 are manufactured together as a single unit. This may be done by cutting or stamping both parts 20 and 10 out of a single sheet of material or by fusing them from two separate materials or two separates segments of the same material. This attachment may be accomplished through melting, stamping, soldering, riveting, or gluing or any other commercially available means of attaching two objects together.

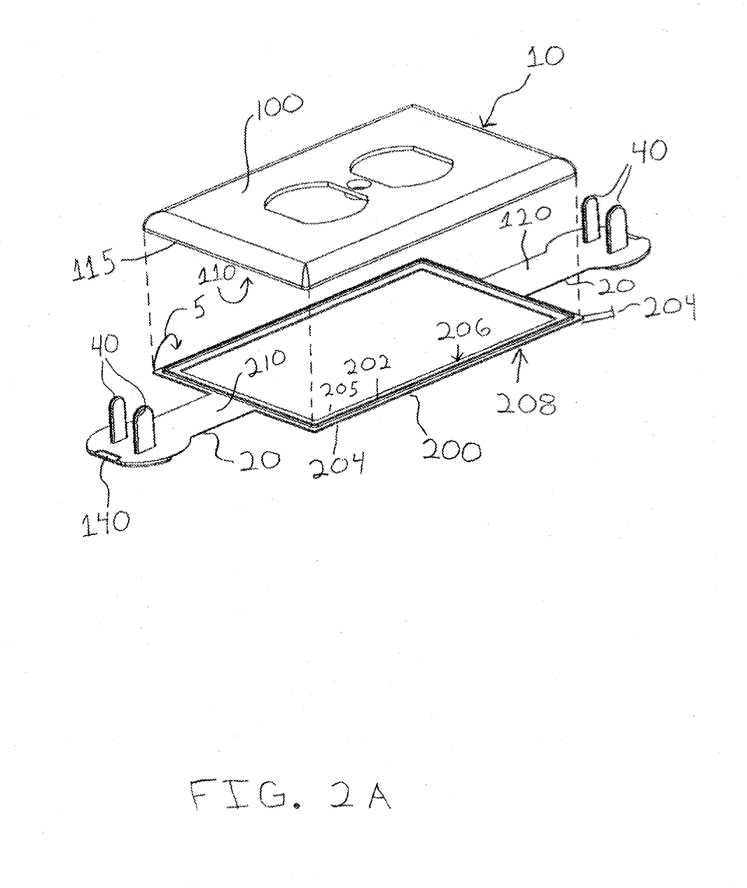

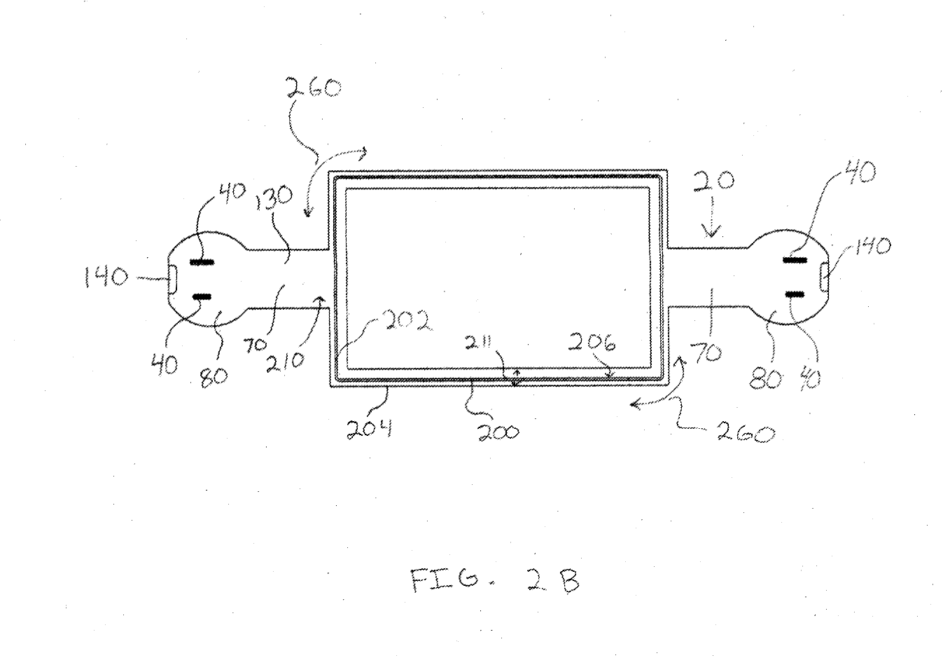

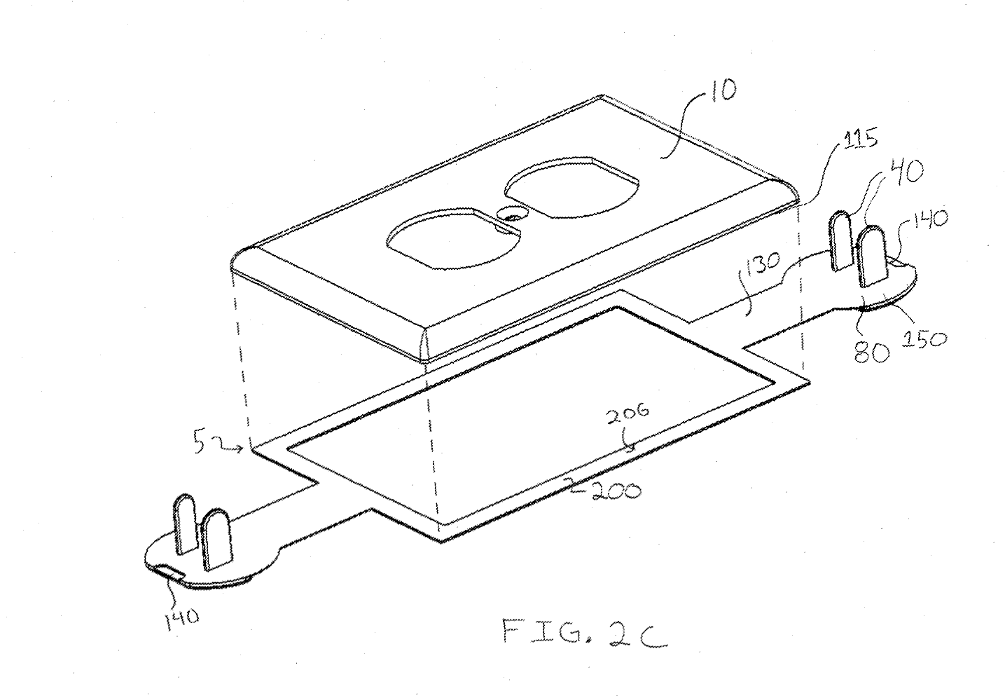

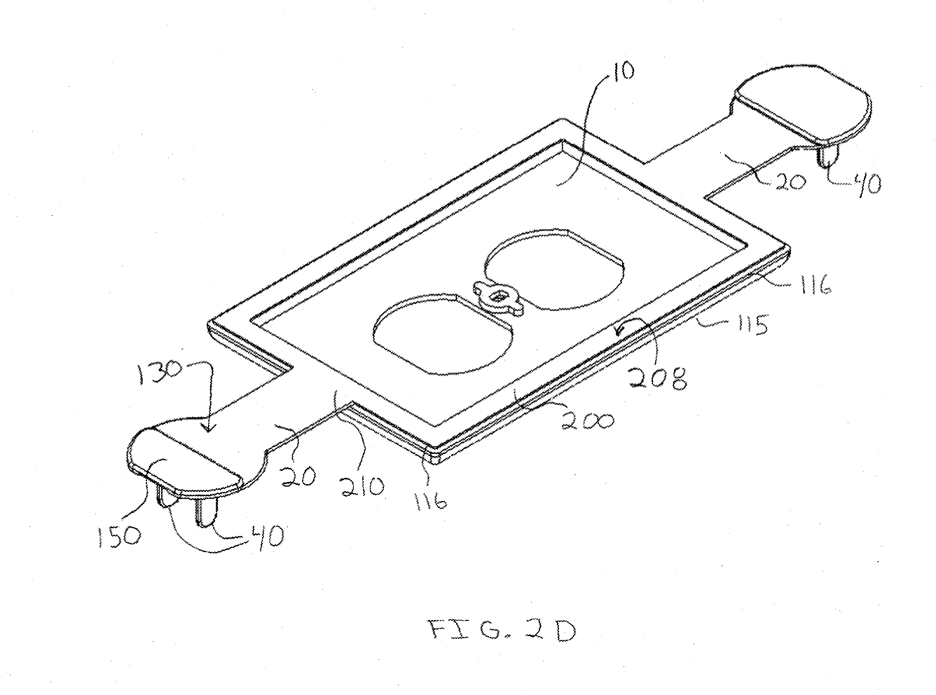

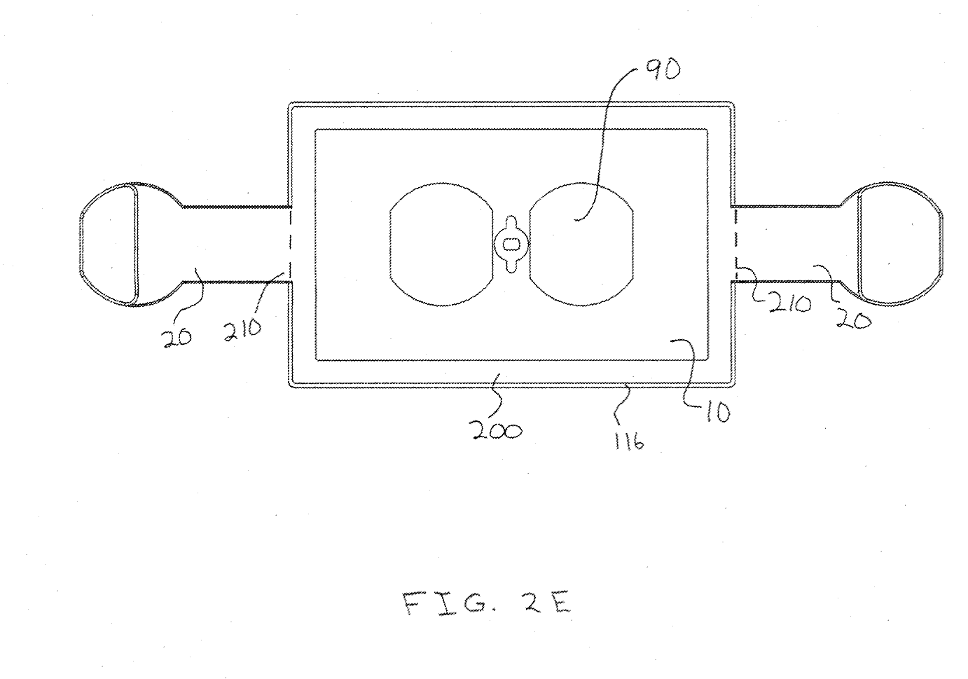

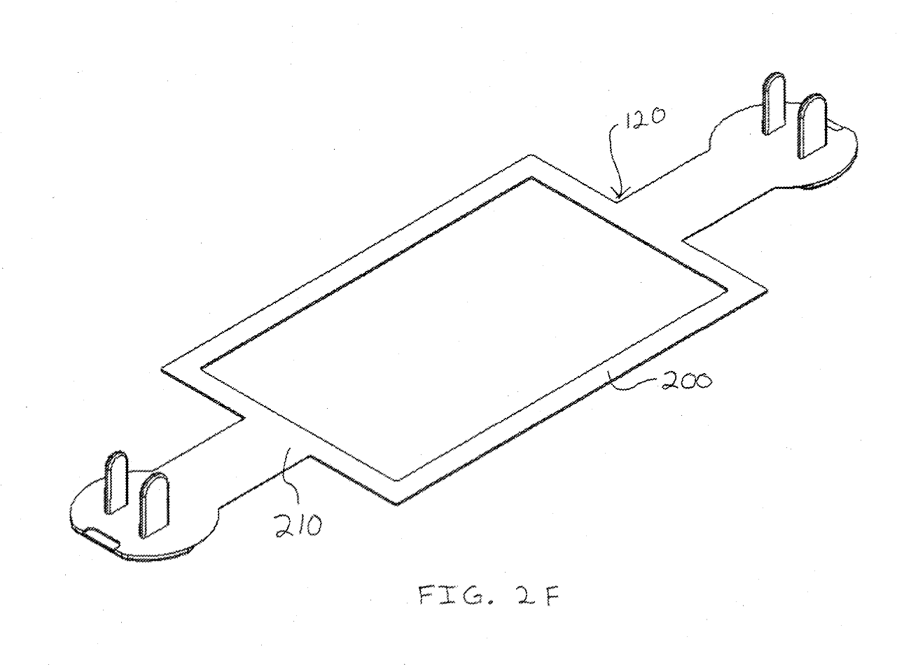

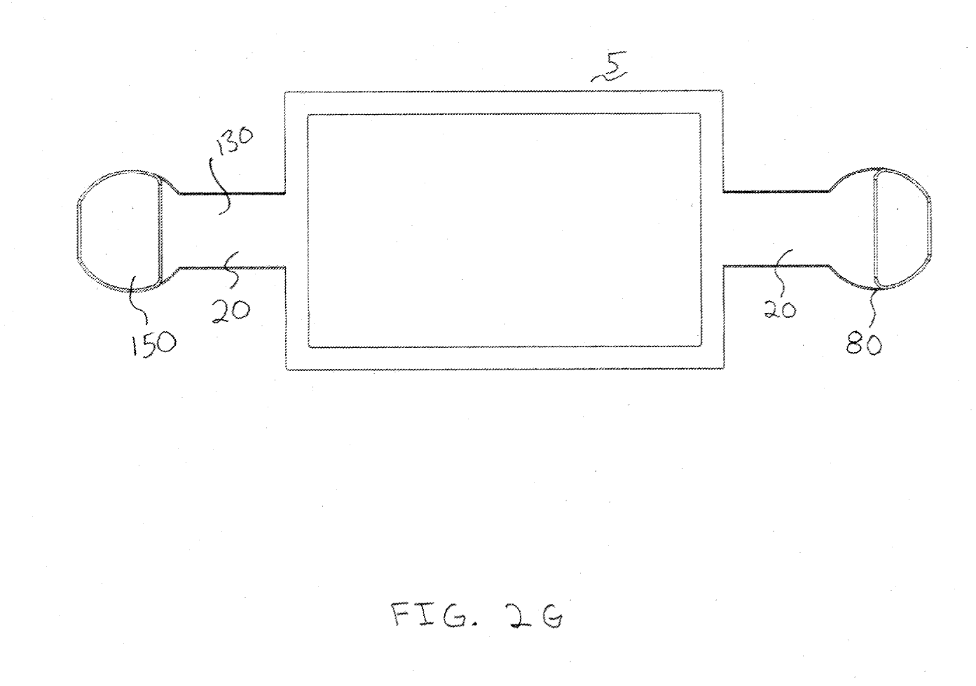

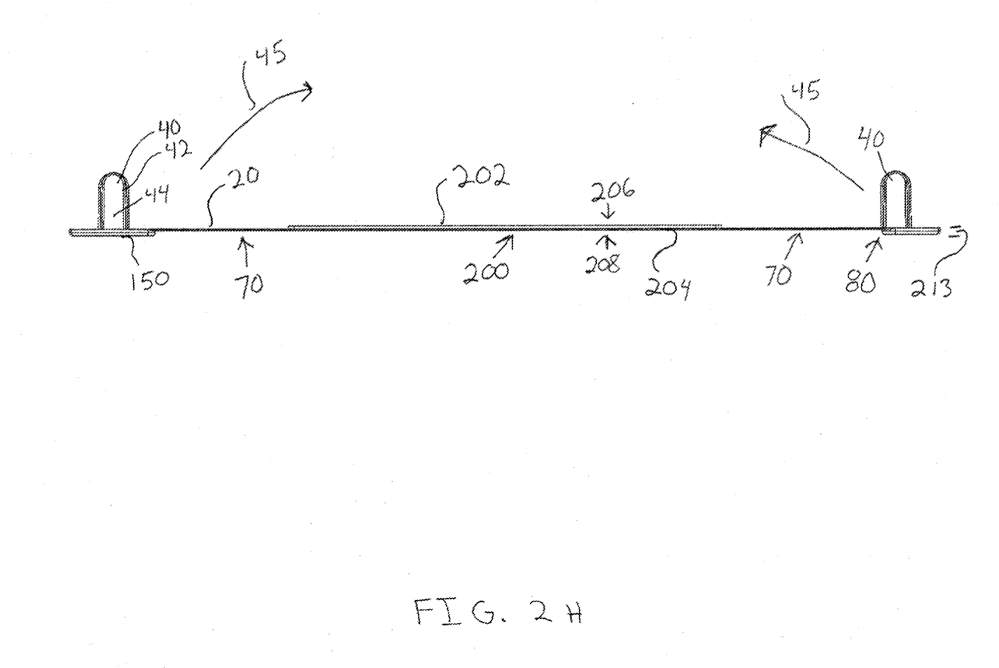

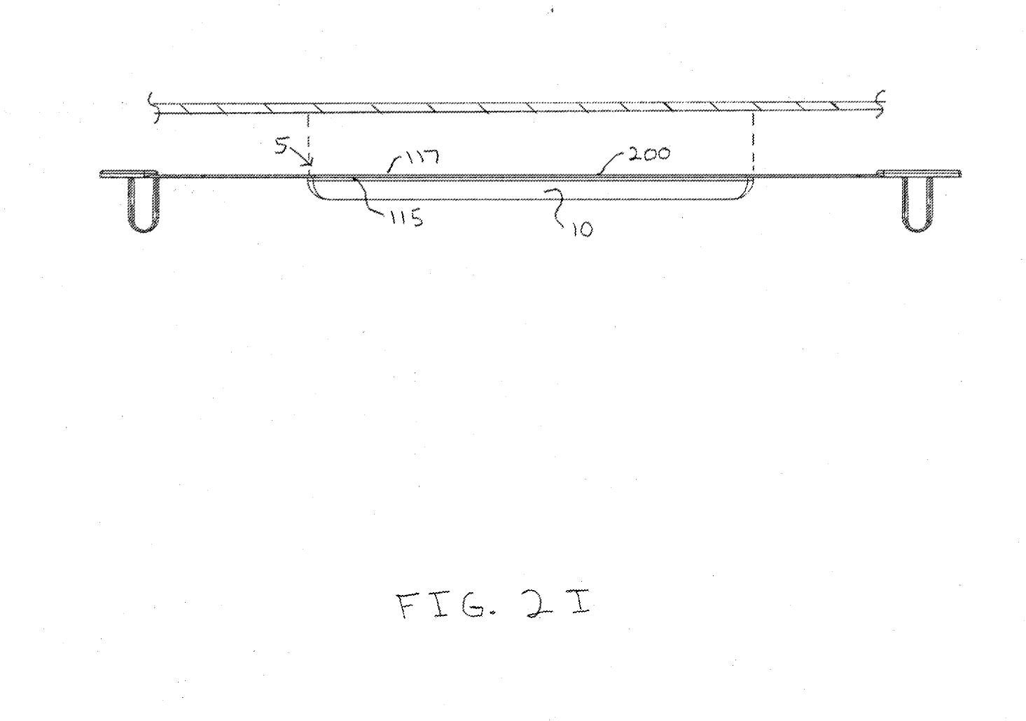

The strap 20 should preferably be manufactured from plastic or resin or any other polymeric material. It may also be manufactured from metal, metal alloy, leather, or fabric. To achieve maximum utility and durability, it is advisable that the band section 70 is flexible, yet possesses sufficient tensile integrity that when not used, it will assume a positional orientation with respect to the top surface 100 that is biased toward keeping access to the aperture 90 unobstructed, as shown in FIG. 1. This quality prevents a strap 20 that is not covering the outlet 300 (FIG. 2) from obstructing any normal use of such electrical outlet 300. To further improve this predisposition, the first point 50 of the band 70 is attached to the bottom surface 110 and then wrapped around the side edge 115. The band 70 can achieve substantially the same effect when attached directly onto the side edge 115. In either event, it may be preferable to have a fold line 220 that is running across the band section 70, at a distance between 2 and 10 millimeters from the side edge 115.

The strap 20 may also be disposed on the outside surface 100, in which case the band 70 may be manufactured in a way that induces it to curl in a direction away from the receptacle cover. The width of the band section 70 should preferably be between 0.08 of an inch or 2 millimeters and 2 inches or 5 centimeters. The band section 70 is preferably straight, as shown. However, the band section may be curved, elliptical, or may be formed in a myriad of other whimsical and fanciful shapes. The top surface of the strap 120, bottom surface of the strap 130 may be molded or colored in a variety of shades and patterns.

In FIG. 1 the cap 80 has shape that resembles a most common electrical outlet used in North America, being substantially elliptical with the longer side 81 of the ellipse flattened out. However, a myriad of other shapes is possible, such as but not limited to, a square, circle or rectangle, or more whimsical shapes such as heads of various creatures, critters, action figures, team logo, or a name. To promote greater durability and structural integrity, the band 70 a the cap 80 and cover 10 are manufactured as a single component that forms the strap 20, cap and cover. The cap 80 may be made narrower or wider than the band 70, or these two areas may appear indistinguishable from each other.

The strap 20 and/or the receptacle cover 10 may be made of luminescent material. Chemiluminescence of such a material may be powered by hardwiring the receptacle cover to the outlet. Energy may also be derived from the electromagnetic forces that surround the outlet. The components of the present invention may also be photo luminescent, in which case no external power source would be required. In another alternative, an LED light source may be embedded within the strap or cap issue point 210. The cap 80 may have metal plug prongs 20, which would serve as conductors for energizing a night light incorporated into said cap 80. Said plug spades would then make contact with internal energized components of the electrical receptacle when in closed state. This light source would light up the translucent straps 20, producing steady or intermittent radiance. Additional LEDs may be disposed along the strap 20 (not shown). The strap 20 or the receptacle cover 20 may further be equipped with on or more electrode and a primitive speaker (shown in later figures), which would emit a sound when the electrode connection between the strap 20 and the receptacle cover 10 is lost.

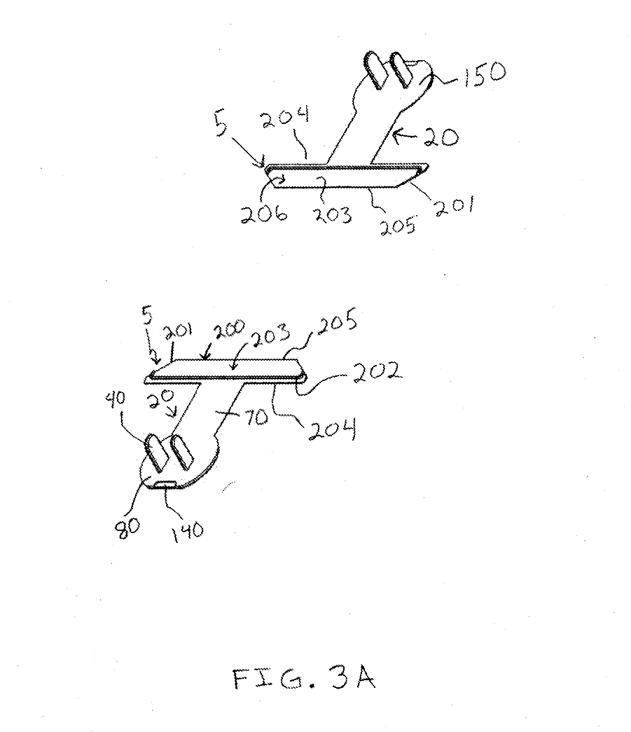

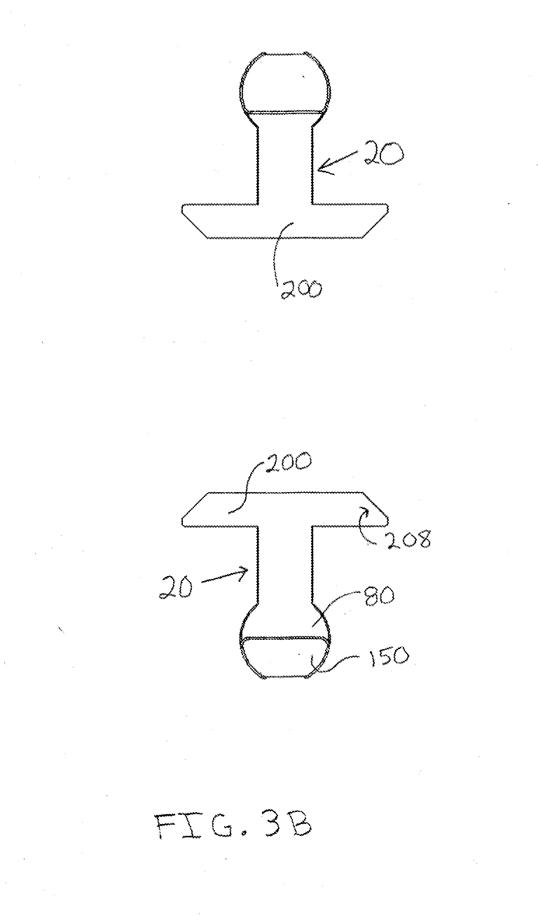

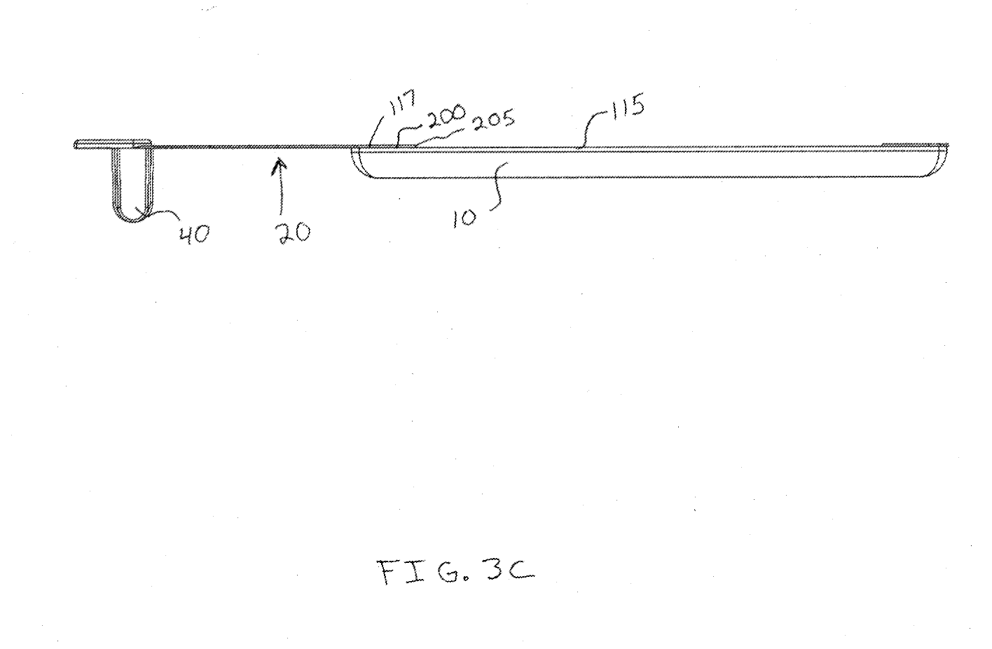

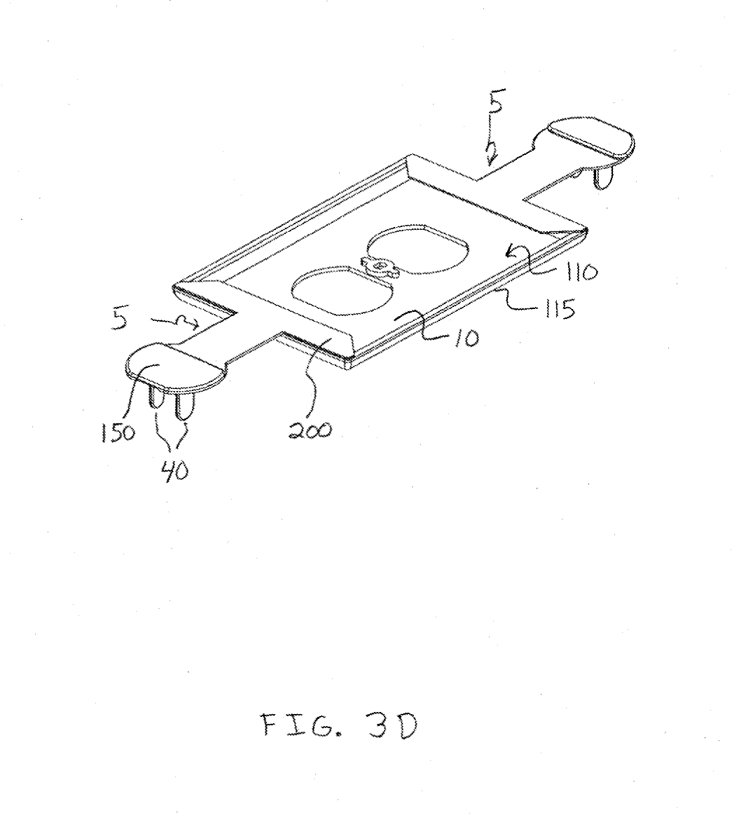

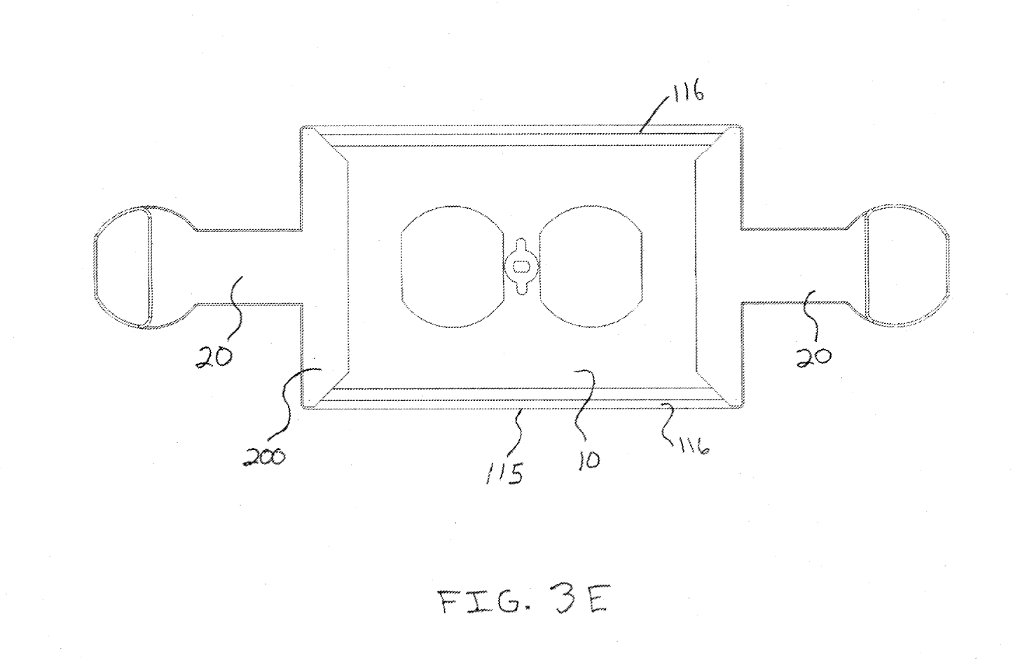

In FIG. 1, the strap 20 is attached in a way that it bends around the short side 55 of the receptacle cover 10. This configuration works best for North American fifteen ampere outlets where the outlet apertures are next to each other and extend into the outlet in a parallel fashion. However, in an alternative embodiment, the band may be bending, around the side 65. This configuration may work better for outlets where the plug receiving apertures are round or at an angle with respect to each other. Only one strap 20 is required, however as many additional straps may be added as necessary. The strap configuration may be pre-molded, as shown in FIGS. 2A-2I or may be more dynamic as in FIGS. 3A-3E.

FIG. 2 shows how the prongs 40 of the straps 20 easily and conveniently drop into receptacle receiving apertures of the outlet 300. The outlet 300 is a plug accepting outlet, meaning the a plug, of a connector, such as electrical two or three prong connector is capable of being inserted into apertures 302 of the outlet 300 to draw energy or to establish a flow of electrons or other signaling impulses. The spatial dimensions of the prongs 40 are such that they fit very snugly within the receptacle receiving apertures, meaning that prying the strap 20 away from the outlet 300 would be a challenge for a child. The prongs 40 may also be polarized for proper fit. Meaning one prong 40 may be larger than the other, as found in most North American plug connectors. However, an adult would be able to utilize the slot 140 in additional to superior strength than a child, to gain access to the outlet 300 without much effort. In an alternative embodiment, the slot 140 may be replaced or supplemented with a prong shape or configuration that would require an adult to shift the strap 20 in a specific sequence. This embodiment may reduce effort for an adult without compromising the security features with respect to pets or children.

The cap 80 further contains the thicker section 150, the prongs 40, the ground indicator 160, and the slot 140. The prongs 40 are attached to the thicker section 150. The extra thickness prevents cracking or snapping of the strap 20 while it is being subjected to prying, pressing and twisting forces when the prongs 40 are being inserted into are pried away from an outlet. The ground indicator 160 is on the top surface 120 of the cover cap 20. The primary purpose of the ground indicator 160 is to identify the top and bottom areas of the receptacle cover 10 during installation. The slot 140 is located at the second point 60. However, in other embodiments, the slot 140 may be situated in any other location along the strap 20. The slot location shown in FIG. 2 is preferred since it provides the greatest leverage when prying the covering surface away from the receptacle cover 10 to expose the electrical cover underneath.

The flange 200 shown in FIG. 2A represents the primary structural component of the safety device 5, which secures the strap 20 into place. The flange 200 may be attached to the bottom surface 110 either with an adhesive or through frictional attachment. The adhesive may be applied to the top surface 206, or to the outer edge 204. The lip 202 serves to better align the flange 200 within the bottom cavity of the cover 10, as shown in the FIGS. 2A and 2D. The flange 200 is preferably plane and is of even thickness over the entire perimeter 260 of the flange 200. Alternatively, the thickness may alternate or may be made of memory polymer, or other resinous materials. When a flexible, variable thickness material is used, the flange will form an air tight seal between the cover 10 and the wall on which the electric outlet is mounted. With as rubberized polymer or a memory plastic material, an air tight seal will form notwithstanding any cracks or other surface imperfections of the edge 115 or on the wall on which the cover 10 is mounted. The thickness 209 of the flange 200 should preferably be between ⅛ of an inch and ½ of an inch, while the width 211 (FIG. 2B) should preferably start at 1/16 of an inch and get wider depending on electrical cover used.

The lip 202 is clearly visible in FIG. 2B. The lip 202 may cover the entire perimeter 260 of the top surface 206. Alternatively the lip 202 may exist in spots where the flange 200 is likely to be come twisted or misaligned, for example along the length of the flange, or in cases of decorative or round wall plates, within curvatures or sharp angles.

FIG. 2C shows the cover 10, the edge 115, the top surface 150, prongs 40, nail tab or flange 140, thick section of 150, the flange 200. The protective device 5 shown in FIG. 2C does not contain an alignment lip 202. Since the lip adds to the thickness 209 (FIG. 2A), in some cases a thinner flange 200 may be desired. One example of this may be a wall plate having a step design around its perimeter that tappers of toward the edge 115, or any other cover design where the separation between a mounting wall and a cover is very small. In addition, if adhesive is applied to the top surface 206, the presence of a lip 202 may be undesirable as it may interfere with proper adhesion. This is especially true if a cover 10 is manufactured together with the safety device 5, and the flange is being fitted right on the conveyer belt. The preferred way of manufacturing the present invention with cover is injection molding for plastics and resins or stamping for metals. Injection molding process may form the cover 10 and the straps 20 as a single piece or separate pieces. The same can be said regarding the flange 200 and the cover 10 and straps 20.

The snug fit of the flange 200 within the inside edge 116 of the cover 10 is visible in FIGS. 2D and 2E. The bottom surface 208 will get jammed against a wall as the cover is fastened onto the electric cover. It is preferred however that no adhesives are used for holding the flange 200 in place. An adhesive or frictional coating may be applied to the bottom surface 208, for a more permanent fit.

The flange 200 should preferably move the edge 115 slightly away from the wall on which the cover plate 10 is being mounted to allow for the passage of the strap 20, while at the same time providing an airtight, even seal all around the perimeter of the cover 10. If the edge 115 is flush with the wall, then the segment of the edge 115 that covers the strap issue point 210 will be slightly raised to allow the strap 20 to pass underneath. This slight elevation may produce undesired gaps between the wail and the cover plate 10 to the left and right of the elevated segment. In addition, the uneven connection between the edge 115 and the wall may cause the cover plate 10 to wobble and oscillate when touched since the connection between the edge 115 and the wall will be uneven. Alternatively, a cover 10 may contain a cutout in the edge 115. This cutout would correspond to the width of the strap issue point 210 and permit for an unobstructed passage of the strap 20. In another alternative, the strap 20 may be molded or attached directly onto the edge 115.

FIGS. 2F and 2G provide an unobstructed front and back views respectively of the safety device 5. Also visible is the top surface of the strap 120, bottom surface of the strap 130. The flange 200 and strap 20 may be multilayered, resulting in a difference in material, color or texture for either or both the top and bottom surfaces 120 and 130. As was noted above, the flange 200 need not be shaped as a rectangle, but may have more elliptical curvatures.

The side views visible in FIGS. 2H and 2I provide clarity into components that may not have been clearly illustrated in prior diagrams. Shown are the prongs 40, the strap 20, the band section 70 the cap 80, the thick section of the cap 150, the flange 200, the lip 202, the outer edge 204, the top surface of the flange 206, and the bottom surface of the flange 208. The prongs 40 contain a curved section 42 and a straight section 44. This accommodates a North American standard of regular voltage electrical outlet. As the strap 20 swings in the direction of the arrows 45, the prongs 40 wilt encounter the plug receiving apertures 302 of the electrical outlet 300 (FIG. 2) at an angle. The curved section 42 allows for a smooth alignment between the apertures 302 and the prongs 40, while the straight section produces a snug and secure fit of the prong 20 within the aperture 302. It will be appreciated by one skilled in the art that the prongs may be molded in any shape, such as, but not limited to conical, cylindrical, or trapezoidal. While the present description focuses on an electrical cover, it is understood that similar safety devices can be made for various other types jacks, such as, but not limited to telephone or network wiring jacks, high voltage and proprietary mechanical or electrical jacks, microphone or audio/video outlets. The jacks or outlet also need not be wail mounted, but may also be found in the floor, ceiling, airplane chairs, and in office furniture or any other location where such outlets may be installed. The thickness 213 of the thick part 150 of the cap 80 is preferably between 2 and 5 millimeters, but may be thicker for some embodiments.

FIG. 2I illustrates described in the discussion for FIGS. 2D and 2E. The flange 200 interposes between the edge 115 of the cover 10 and the wall 15, by a thickness of the flange 117. The thickness of the flange 117 is preferably just a few millimeters so as to be discernible only after a careful inspection. Otherwise, the appearance of a mounted cover 10 will be substantially the same as any other cover that is not secured by the protective device 5.

FIGS. 3A through 3E illustrate another embodiment of the present invention. In these figures each protective safety device 5 is made up of several unconnected components, mainly consisting of a flange 200 and a strap 20. The embodiment shown in FIGS. 3A-3C may be preferable in cases where one of the gangs of the cover 10 needs to accommodate an irregular outlet. For example, one gang would contain a standard electrical outlet, while the other would contain high voltage line, or a phone line. A kit containing a protective device 5 may contain straps 20 with prongs 40 to accommodate several known types of outlets. A consumer or electrician implementing the protective device 5, would then have the flexibility of choosing the right protective device 5 for each individual outlet 300 (FIG. 2).

Shown in FIGS. 3A-3E are a strap 20, a band 70, a cap 80, prongs 40, a nail tab 140, and a thick section of the cap 150. The primary difference in this embodiment than in FIGS. 2A-2I is the appearance of the flange 200. Shown is the outer edge 204, the inner edge 205, the connecting edge 201, the lip 202, and the inner section of the flange 203. The outer edge 204 may fit over the inner edge 116 and be flush with the segment of the edge 115 which is contact with the flange 200. This is especially preferred in an embodiment the neither the top surface 206 nor the bottom surface 208 contains any adhesive. The flange 200 is squeezed and held in place by the inner edge 116 once the cover 10 is tightly mounted onto the outlet 300. In embodiments containing adhesive coating for either the top or bottom surfaces 206 or 208, the outer edge 204 may fit within the inner edge 116.

The connecting edge 201 is preferably cut at an angle, in particular figure at a 45° angle. This is done so that another protective devices 5 may be installed next to each other both on a straight line or perpendicularly to each other. The lip 202, if included, promotes proper alignment of the flange 200 and the cover bottom surface 110 of the cover 10. The inner section of the flange 203, is preferably wider than in the embodiment shown in FIGS. 2A-2I. A larger inner flange provides greater contact with the bottom surface 110. The larger size is preferred as it promotes greater adhesion and stability of the protective device 5, once it is installed between the edge 115 and the wall 15. Either the top surface 206, or the bottom surface 208, or the bottom surface 110 of the cover 10 may be coated with an adhesive or frictional substances or frictional patterns, to improve the permanence of the protective device installation.

FIG. 3C is a side view of this embodiment. The edge 115 will be slightly pushed away from the wall by the thickness of the flange. The inner edge 205 is the farthest extent of the flange 200 for the embodiment shown, which would mean that there would a slight gap between the edge 115 and the wall 15, where the flange 200 has not been installed. The cover 10 will not wobble when installed, despite the fact that there is no even seal between the cover 10 and the wall 15. The stability is attributed to the fact that the outer edge 204 stretches between two adjoining corners and incorporates these corners. That means that the entire one side of the cover 10 is slightly pushed away from the wall, and not just one corner or a segment of the edge 115.

The thickness of the flange 200 at the inner edge 205 may be thicker than the thickness at the outer edge 204. This may be done to accommodate the concave structure of the bottom surface 110 of most covers 10. The thicker part will promote a flush and level connection plane of the bottom surface 200 with the wall 15.

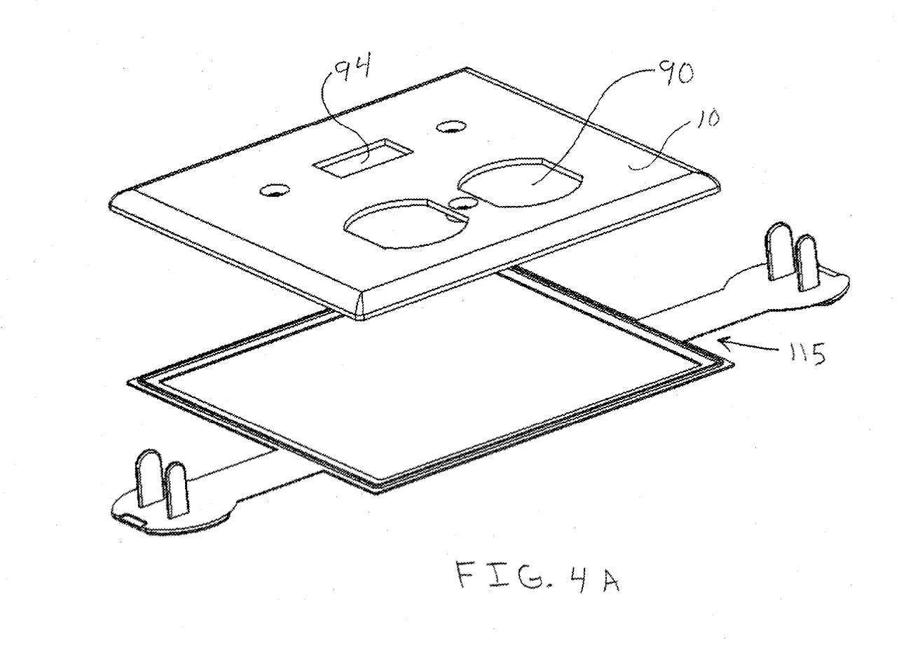

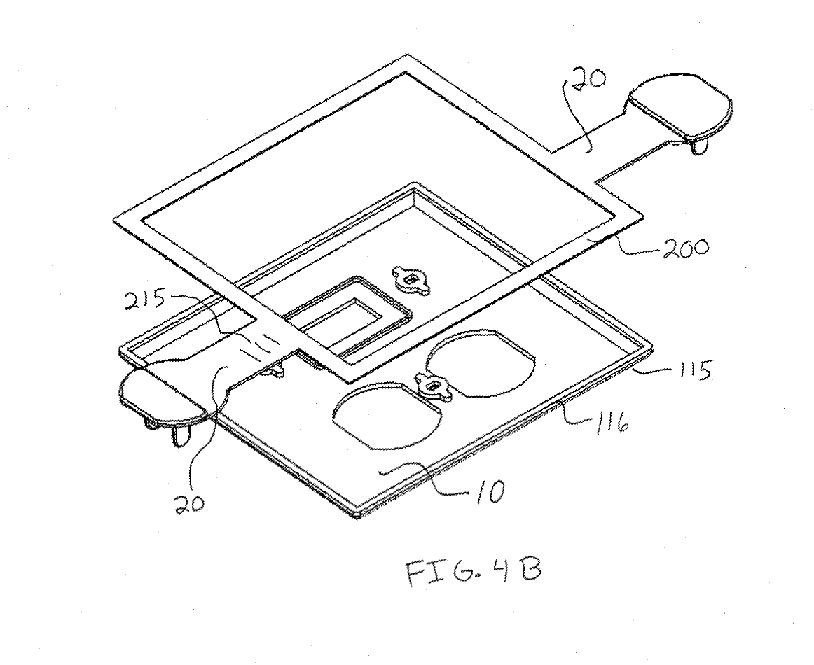

FIGS. 4A and 4B demonstrate how the present invention may function with other types of wall plate covers 10. Shown is a cover with dual apertures 90 for electric outlets, and a single adjacent toggle switch. In this embodiment, the flange 200 still covers the perimeter of the outlet cover, which now includes the toggle switch aperture 94. The hermetic seal of the flange also 200 helps prevent moisture and carbon buildup inside the electric receptacle housing, which in turn would inhibit oxidation and mold buildup in warm or damp environments.

In an alternative embodiment. FIG. 4b shows signal device 215 on one of the straps 20. A signal device would emit certain audiovisual signal whenever the safety device 29 would be removed from the outlet it protects. As mentioned earlier, one or more of the caps 80 may house a small light source, such as an LED bulb, and serve as a night light when the straps 20 are covering the outlet 300 and the prongs are submerged within the plug receiving apertures 302. Such a signal device 29 may derive power from the same electrical outlet through hard wiring, or through one of the methods already discussed above, or through by utilizing the electromagnetic field around the outlet (from the AC wiring). The technology for tapping power from an electromagnetic field to light a lighting device is known to those skilled in the art. An example of such technology is evidenced by a conventional NON-CONTACT AC POWER DETECTOR, manufactured by Bel-Merit.

It is understood by those skilled in the relevant art that the embodiment of the present invention that is discussed in this application represents the preferred embodiment. However, the description extends to alternative embodiments of the present invention that are not shown in the Figures.

What is claimed:

1. A protective device for a plug accepting device comprising;
at least one strap, said strap having at least one prong that is capable of being inserted into a plug receiving aperture of an outlet;
a flange, said flange accommodating said at least one strap; and
said flange securely mounting unto said cover.

2. The protective device of claim 1, wherein said outlet is an electrical outlet.

3. The protective device of claim 1, wherein said strap is biased in a direction away from said aperture.

4. The protective device of claim 1, wherein said strap contains a fold section, said fold section facilitating the bending of said strap toward said electrical outlet.

5. The protective device of claim 1, wherein said flange further comprises a lip, said lip capable of air tight seal between said flange and said cover.

6. The protective device of claim 1, wherein said strap further comprises a night light.

7. The protective device of claim 1, wherein said flange is plane strip of material that attaches along one side of said electrical cover.

8. The protective device of claim 1, wherein said flange is plane strip of material that attaches to the bottom surface of said electrical cover.

9. The protective device of claim 1, wherein said flange is as plane strip of material encompassing a perimeter of said electrical cover.

10. Additional claim the protective device of claim 1, wherein said flange is manufactured out of material having memory characteristics.

11. The protective device of claim 1, wherein said strap is luminous.

12. The protective device of claim 1, further comprising a signal device; said signal device emitting a signal when said prong is removed from said electrical outlet.

13. The protective device of claim 1, wherein said signal device is powered from said electrical outlet.

14. The protective device of claim 1, further comprising another strap; said other strap having at least one prong.

15. An electrical cover with an integrated safety device comprising;
an electrical cover having at least one aperture; said electrical cover mounting on an electrical outlet;
said aperture matching with an electrical gang of said electrical outlet;
at least one strap, said strap having at least one prong; said at least one strap being biased to remain in a position away from said electrical outlet;
said strap capable of being bent in a direction such that said prong is capable of being inserted into an aperture of an electrical outlet; and
said electrical cover incorporating said at least one strap.

16. The electrical cover of claim 11, further comprising a flange; said flange mounting to a bottom side of said electrical cover.

17. The electrical cover of claim 11, wherein said flange further contains a lip.

18. The electrical cover of claim 11, wherein said at least one strap is mounted on an edge of said electrical cover.

19. In combination an outlet cover with a protective device comprising;
an outlet cover having at least one aperture; said outlet cover mounting on a plug accepting outlet;
said outlet cover having at least one flange mounting thereto;
said flange providing support for at least one strap wherein said strap tending to remain in a freestanding position when not used to block said plug, accepting outlet; and
said strap having at least one prong, said prong capable of being inserted into said plug accepting outlet to retain said outlet cover in a position that substantially covers said plug accepting outlet.

20. The combination of claim 17, wherein said flange is made of flexible material capable of forming a seal between an outlet cover and a surface onto which said outlet cover is mounted; and wherein said flange is mounted on the bottom surface of said outlet cover.
